(19) United States
(12) Patent Application Publication
(10) Pub. No.: US 2019/0114074 A1
(43) Pub. Date: Apr. 18, 2019

(54) MULTI-LANGUAGE USAGE SYSTEM

(71) Applicants: MICHAEL W. STARKWEATHER, TAMPA, FL (US); Kenneth S. Kinkel, ST. GEORGE, UT (US)

(72) Inventors: MICHAEL W. STARKWEATHER, TAMPA, FL (US); Kenneth S. Kinkel, ST. GEORGE, UT (US)

(21) Appl. No.: 15/784,651

(22) Filed: Oct. 16, 2017

(51) Int. Cl. G06F 3/0488; H04M 1/725; G06Q 20/10

(52) U.S. Cl. CPC G06F 3/04886; H04M 1/72552; H04M 2250/70; H04M 2250/58; G06Q 20/102

(57) ABSTRACT

A system to enable a first and second electronic device to select at lest one digitized language from up to about 2600 digitized languages and thereby send text messages in the selected language between the first and second electronic device. The steps comprising acquiring a first and second electronic device; providing a central server for storing up to about 2600 digitized languages; requesting, from the first and second electronic device, access to a first digitized language out of the up to about 2600 digitized languages; locating the requested first digitized language in the central server out of the database of up to about 2600 languages; allowing the first and second electronic device to download the requested first digitized language out of the up to about 2600 digitized languages on to the first and second electronic device; sending a text message from the first electronic device to the second electronic device using the first digitized language received from the central server.

### BACKGROUND OF THE INVENTION

### Field of the Invention

The present invention relates generally to a field of optimization of soft keyboards, and more specifically, to a business system and method for creating and providing optimized soft keyboards for multiple languages to enable text messages using telecommunications in languages hertofor unaccessable.

### Description of the Related Art

According to some at the United Nations, there are over 3 billion people that do not have access to texting on their phones. Texting is a less expensive means for communication than talking on the phone. In many third world countries texting is not enabled because of the digitization of languages has heretofore gone unaddressed and the method of supplying such to around 2600 different languages. Wherein, only about 20 or so languages are provided on texting devices as of today for users to use for texting, which is far short of the 2600 languages in common use.

The loading of a language onto a smart phone, for example, may usually be preprogrammed into the device and upon booting up the device the user is asked to select the desired language, like English or Spanish. The size of the available memory in a smart phone is sufficient to store only a few languages and nowhere near has the storage available to store around 2600 languages.

For example, the following patents are provided for background information, and are herein incorporated by reference for their supportive teachings, wherein:

U.S. Pub. No.: 2008/0150900, to Han, pub. Date, Jun. 26, 2008, discloses an image forming apparatus and method of displaying multilingual keyboard using the same.

U.S. Pub. No.: 2011/0063141, to Gabay, pub. Date, Mar. 17, 2011, discloses an adaptable keyboard system.

U.S. Pub. No.: 2008/0152577, to Yuen, pub. Date, Jun. 5, 2014, discloses a system and method for a symbol adaptable keyboard.

U.S. Pub. No.: 2014/0281995, to Kim, pub. Date, Sep. 18, 2014, discloses a mobile terminal and modified keypad using method thereof.

U.S. Pub. No.: 2014/0145962, to Radhakrishnan, pub. Date, May 29, discloses a recipient aware keyboard language.

U.S. Pub. No.: 2015/0058430, to Shankarappa, pub. Date, Feb. 26, 2015, discloses a method and system for changing a keypad language and electronic device thereof.

U.S. Pub. No.: 2015/0121282, to Kangas, pub. Date, Apr. 30, 2015, discloses a dynamic virtual keyboard responsive to geographic location.

U.S. Pub. No.: 2014/0035823, to Khoe, pub. Date, Feb. 6, 2014, discloses a dynamic context based language determination.

Hence there exists a need for a system and method for providing a system and method of managing and providing user access to multiply languages, and potentially to over 2600 languages and variations thereof around the world, and for creating unique keyboard layouts for one or more languages, which have keys optimally, arranged for easy access by the native speakers of the particular language. Moreover the needed system and method would provide a unique keyboard layout and key guides for typing one or more languages sharing the same characters. In addition, the needed system and method would allow the users to access a desired keyboard layout of a desired language using a system and method for supplying access to multiple languages for downloading thereof.

### SUMMARY OF THE INVENTION

In view of the foregoing disadvantages inherent in the known types of systems like in the prior arts, the present invention may provide in whole or in part a business method and a computer-implemented system for enabling a first and second electronic device to select at lest one digitized language from up to about 2600 digitized languages and thereby send text messages in the selected language between the first and second electronic device, comprising the steps of: acquiring a first and second electronic device; providing a central server for storing up to about 2600 digitized languages; requesting, from the first and second electronic device, access to a first digitized language out of the up to about 2600 digitized languages; locating the requested first digitized language in the central server out of the database of up to about 2600 languages; allowing the first and second electronic device to download the requested first digitized language out of the up to about 2600 digitized languages on to the first and second electronic device; and sending a text message from the first electronic device to the second electronic device using the first digitized language received from the central server. The system further comprising the step of sending from the central server a request for payment related to the first digitized language to the first and second electronic device. The system further comprising the step of receiving a request for payment from the central server at the first and second electronic device. The system further comprising the step of sending an appropriate payment from the first and second electronic device to the central server. The system further comprising the step of receiving the associated payment from the first and second electronic device at the central server.

In another embodiment of the invention there is a computer-implemented system for allowing a plurality of users to use at least one text input in a plurality of languages, the system comprises: an electronic device having at least one processor capable of executing a plurality of instructions of a plurality of applications including an interactive soft keyboard application; a memory unit in communication with the processor for storing the plurality of instructions of the interactive soft keyboard application capable of being executed by the processor to allow the users to provide the text inputs in the plurality of languages including a plurality of digitized languages and non-digitized languages; at least one server in communication with the interactive soft keyboard application running on the electronic devices to provide an interactive soft keyboard for each of the plurality of languages; wherein the server stores a plurality of complete character sets for a plurality of languages and a plurality of custom keyboard layouts based on the complete character sets for each of the plurality of languages and made accessible to the electronic devices through the interactive soft keyboard application running on the electronic devices; and wherein the interactive soft keyboards for each of the languages displayed through the interactive soft keyboard application running on the electronic devices is based on the plurality of custom keyboard layouts stored in the server; and a wireless communication network for enabling communication between the electronic devices and the server for receiving the plurality of custom keyboard layouts based on the complete character sets for each of the plurality of languages stored in the server; whereby the interactive soft keyboards on the electronic devices presents the custom keyboard layouts for each of the languages stored in the server and having a plurality of characters, a plurality of punctuation marks and a plurality of special characters forming the complete character sets of the language arranged in a unique layout close to an arrangement of a standard keyboard layout including a QWERTY keyboard layout. Also, the computer-implemented system has custom keyboard layouts for each of the languages stored in the server includes a plurality of keys assigned to the plurality of characters, the plurality of punctuation marks and the plurality of special characters of the language based on a frequency of use of each the characters, the punctuation marks and the special characters in the language; at least one similarity in a shape of the character, the punctuation mark and the special character in the language with the shape of the character, the punctuation mark and/or the special character in a widely used language having a standard keyboard layout; and at least one similarity in a sound of the character, the punctuation mark and the special character in the language with the sound of the character, the punctuation mark and/or the special character in the widely used language having the standard keyboard layout. The computer-implemented system also has the standard keyboard layout is selected from a group consisting of a plurality of standard QWERTY-based Latin-script keyboard layouts, a plurality of standard non-QWERTY-based Latin-script keyboard layouts and an established national keyboard layout. The computer-implemented system also has the widely used language is selected from a group consisting of: a widely used Latin-scripts based language including English having the standard QWERTY-based Latin-script keyboard layout; a widely used Latin-scripts based language having the standard non-QWERTY-based Latin-script keyboard layout; a widely used non-Latin alphabetic scripts based language having the standard non-QWERTY keyboard layout; and a widely used non-Latin alphabetic scripts based language having the established national keyboard layout. The computer-implemented system also has the interactive soft keyboard application launched from the electronic device allows the users to: search for a desired custom keyboard layout for a selected language having the complete character sets stored in the server; download the desired custom keyboard layout for the selected language within the electronic device; access the interactive soft keyboard displaying the custom keyboard layout for the selected language; and provide a plurality of textual inputs in the selected language using the interactive soft keyboard launched within a plurality of applications running on the electronic device.

These together with other features of the invention, along with the various features of novelty, which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. Elements in the figures have not necessarily been drawn to scale in order to enhance their clarity and improve understanding of these various elements and embodiments of the invention.

Furthermore, elements that are known to be common and well understood to those in the industry are not depicted in order to provide a clear view of the various embodiments of the invention, thus the drawings are generalized in form in the interest of clarity and conciseness. The invention will be described and explained with additional specificity and detail through the use of the accompanying drawing in which:

FIG. 1 illustrates a schematic diagram of a system for allowing users to provide a text input in a number of languages, according to a preferred embodiment of the present disclosure.

FIG. 2 is a block diagram showing the different components and modules of the electronic device running an interactive soft keyboard application for assisting users to provide a text input in a number of languages including a native language of the user, according to a preferred embodiment of the present invention.

FIG. 3 is a block diagram showing the different components and modules of the server in communication with the electronic device running the interactive soft keyboard application for assisting users to provide a text input in a number of languages including a native language of the user, according to a preferred embodiment of the present invention.

FIG. 4 is a flowchart showing the steps for creating the unique interactive soft keyboard layouts based on a custom keyboard charts for each language, according to a preferred embodiment of the present invention.

FIG. 5 is a flowchart showing the steps of the computer-assisted method for creating a digital character set(s) of existing digitized and non-digitized languages including many regional languages and local variations of these languages and thereafter forming a unique interactive soft keyboard layout for each of these languages, according to a preferred embodiment of the present invention.

FIG. 6 illustrates a computer-implemented system involving the electronic devices for allowing the users to access the unique keyboard layouts for all the languages stored in the server to provide text inputs in a number of languages through the interactive soft keyboards displayed on the smart electronic device of the user, according to an embodiment of the present disclosure.

FIG. 7 illustrates a computer-implemented system involving the electronic devices such as a computer for allowing the users to access the unique keyboard layouts for all the languages stored in the server to provide text inputs in a number of languages through the interactive soft keyboards displayed on the electronic devices, according to an embodiment of the present disclosure.

FIG. 8 shows a physical keyboard having keys arranged based on the custom keyboard chart in a QWERTY layout, created using the present computer-implemented system, according to an embodiment of the present invention.

FIG. 9 is a schematic diagram showing the use of the custom keyboard layouts, of one or more languages created using the present computer-implemented system, in a feature phone, according to an embodiment of the present invention.

FIG. 10 is a schematic diagram showing the use of the custom keyboard layouts, of one or more languages created using the present computer-implemented system, in a smartphone, according to an embodiment of the present invention.

FIG. 11 is a swim lane diagram illustrating one embodiment a business method for allowing users access to and downloading from the up to and about 2600 digitized languages.

### DETAILED DESCRIPTION OF THE INVENTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention. The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

Further, various inventive features are described below that can each be used independently of one another or in combination with other features. However, any single inventive feature may not address any of the problems discussed above or only address one of the problems discussed above. Further, one or more of the problems discussed above may not be fully addressed by any of the features described below. The following embodiments and the accompanying drawings, which are incorporated into and form part of this disclosure, illustrate one or more embodiment of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### Glossary of Terms

As used herein, a “computer system” or “system” or “computer assisted system” or “computer-implemented system” are all similar wording that may refer to a networked system having one or more computers and/or other electronic devices, where each computer/electronic device may include computer-readable medium embodying software to operate the computer/electronic device or one or more of its components. Non-limiting examples of a computer system may include: a distributed computer system for processing information via computer systems linked by a network; and, two or more computer systems connected together via a network for transmitting and/or receiving information between the computer systems.

As used herein, the term “processor” may refer to any device or portion of a device or apparatus that processes electronic data from registers and/or memory to transform that electronic data into other electronic data that may be stored in registers and/or memory. A “computer system” may comprise one or more processors.

As used herein, the term “computer-readable medium” or “storage media” or “memory unit” or “non-transitory computer-readable media” refers to any medium that participates in providing data, for example, instructions, which may be read by a computer, an electronic device, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G etc.

As used herein, the term “Application” and/or “Software” refer to all, or a portion, of a computer program or software code that carries out a specific function and may be used alone or combined with other programs. It comprises computer program instructions adapted for execution by a hardware element, such as a processor, wherein the instruction comprise commands that when executed cause the processor to perform a corresponding set of commands. The software may be written or coded using a programming language, and stored using any type of non-transitory computer-readable media or machine-readable media well known in the art. Examples of software in the present disclosure comprise any software components, programs, applications, computer programs, application programs, system programs, machine programs, and operating system software.

Examples of software code in applications may include: code segments in one or more computer-readable languages; graphical and or/textual instructions; applets; pre-compiled code; interpreted code; compiled code; and computer programs. Computer program code for carrying out operations for aspects of the various embodiments may be written in any combination of one or more programming languages, such as: an object oriented programming languages and/or conventional procedural programming languages, and/or programming languages such as, for example, Hypertext Markup Language (HTML), Dynamic HTML, HTML5, Extensible Markup Language (XML), Extensible Style sheet Language (XSL), Document Style Semantics and Specification Language (DSSSL), Cascading Style Sheets (CSS), Synchronized Multimedia Integration Language (SMIL), Wireless Markup Language (WML), JAVA; JavaScript, JINI, C, C++, Objective C or any language operable on a wireless platform like iOS, Ruby, Ruby on Rails, Perl, UNIX Shell, Visual Basic or Visual Basic Script, Virtual Reality Markup Language (VRML), ColdFusion™; Adobe Flash & related languages; or other compilers, assemblers, interpreters or other computer languages or platforms.

As used herein, the term “Electronic Computing Device” or “Electronic Communication Device” or “Electronic Device” refers to a device potentially comprising at least one processor, a graphical user interface, such as a smartphone, laptop, desktop, tablet, wearable smart device, flip phones, other text able phones, etc., as well as any device defined herein as a “computer” or “device”.

As used herein, the term “Graphical User Interface,” (GUI) or “Dynamic Graphical User Interface” refers to all the visually identifiable and/or intractable visuals displayed through a display of the electronic computing device.

A “client-side” application may refer to an application, a page associated with that application, or some other resource or function invoked by a client-side request to the application.

A “server-side” application may refer to an application running on the server in communication with the “Electronic Computing Device” or the “Electronic Communication Device” or the “Electronic Device” and is cable of exchanging, storing and processing data received from the client side application running on the “Electronic Computing Device” or the “Electronic Communication Device” or the “Electronic Device”.

As used herein, the term “network” or “communication networks” or “communication channel” may operate, for example, with any of a number of protocols, wireless, WiFi, and such as Internet protocol (IP), asynchronous transfer mode (ATM), and/or synchronous optical network (SONET), user datagram protocol (UDP), and IEEE 802.x.

As used herein, the term “soft keyboard” may refer to a keyboard projected on a GUI or computer screen, which may be activated by touching the GUI at the location projecting a key representing a particular key of a standard physical key on a physical keyboard. However, all reference to the term “soft keyboard” shall also include, and not leave out, the concept of using a hard physical keyboard, such as found on many cell phones or flip phones with hard letter keys on the number keys, or “Electronic Computing Device” or “Electronic Communication Device” or “Electronic Device.”

The following section summarizes some aspects or embodiments of the present disclosure and briefly introduces some preferred embodiments. Simplifications or omissions in this section as well as in the abstract or the title of this description may be made to avoid obscuring the purpose of this section, the abstract and the title. Such simplifications or omissions are not intended to limit the scope of the present disclosure nor imply any limitations.

The present invention generally relates to a method of doing business to enable a user to select from a database of digitized text able language sets and use such on a “Electronic Computing Device” or “Electronic Communication Device” or “Electronic Device”, also referred to as a computer-implemented system and method for providing a number of unique keyboard layouts and associated digital language sets corresponding to a large number of digitized and non-digitalized languages including many regional languages and presenting the unique keyboard layouts (in physical form or software form) to the users through an electronic device such as, but not limited to, a computer or tablet or a smartphone or a feature phone, according to a preferred embodiment of the present invention. Further the present system and associated method may provide a number of unique keyboard layouts having a variety of unique key guides for a large number of digitized and non-digitalized languages including many regional languages and local variations of these languages existing today. Thus, the present system and associated method allows the users to provide text information in their regional or native language through their personal electronic devices such as, but not limited to, a computer, tablet, smartphone, feature phone, text able phone, etc. Further, the present system and method provides at least an interactive soft keyboard having a number of characters or letters, punctuation marks and special characters of the regional language(s) of the user arranged optimally and ergonomically in the interactive soft keyboard for easy and fast access by the user through a display means of the electronic device. In addition, the present business method may include a system and method providing access to multiple unique keyboard layouts having a number of characters or letters, punctuation marks and special characters of the regional language(s) of the user arranged optimally and ergonomically on a number of physical buttons provided on the electronic devices. The present digital language sets and the unique keyboard layouts associated with each of the digital language sets can be utilized by a variety of third party applications and digital service providers to communicate directly and in the same language with their users or customers effectively without using existing language translation applications. The present invention also optimizes the existing interactive soft keyboard layouts or interactive soft keyboards, such as QWERTY keyboards or keyboards similar to QWERTY keyboards, to represent the multiple letters or characters, punctuation marks and special characters of many languages including regional languages and local variations of these languages effectively, enabling the local users to exchange text information in their local language using the text features of their electronic device and have to use their voice features of their electronic device that is more expensive than the text features.

The present invention further provides a business method including the use of an interactive soft keyboard application that can be downloaded, installed and run on a variety of electronic devices including, but not limited to, a computer or tablet or a smartphone to enable the local users to communicate via texting in their local or regional language. The users can select a desired language and the associated interactive soft keyboard layout to be displayed on the display means (GUI) of the electronic device through the interactive soft keyboard application. Further, the users may download or access a number of other interactive soft keyboard layouts corresponding to other regional languages from a central server having a number (up to about 2600 languages) of digital language sets and associated interactive soft keyboard layouts.

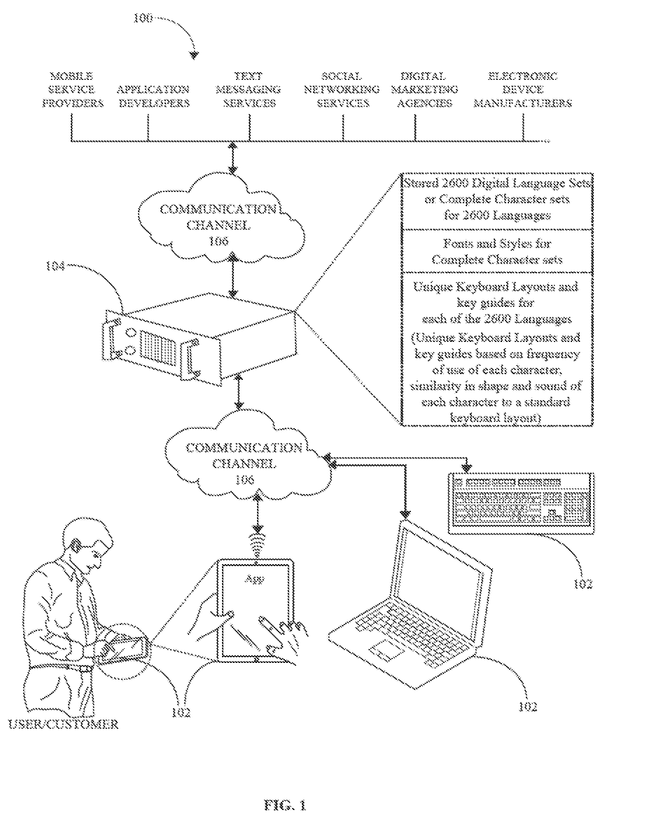

Referring now to FIG. 1, there is illustrated a block diagram of a computer-implemented system 100 for allowing multiple users to provide and receive text inputs in a number of languages through an electronic devices 102 owned by a single or multiple users. The present computer-implemented system 100 allows the users to communicate via text inputs in a number of languages, including a large number of regional languages, selected by the users on their individual electronic devices 102 having one or more processors capable of executing one or more instructions of a number of applications including an interactive soft keyboard application configured to run on the electronic devices 102. The interactive soft keyboard application may include a number of instructions stored in a memory unit of the electronic device 102 and in communication with the processor of the electronic device 102. These instructions, when executed by the processor, enable the users to provide text inputs in a number of languages including a desired language selected by the user, which may be from a list of available digitized languages stored in the memory unit in the electronic device 102, or stored remotely therefrom and down loadable thereto. The present computer-implemented system 100 further may include a server 104 in communication with the applications running on the electronic devices 102. In some embodiments, the server 104 runs one or more applications including an application to communicate with the interactive soft keyboard application running on the electronic device 102. The server 104 may include a number of digital language sets for a number of digitized or non-digitized languages, such as many regional languages and their local variations, in existence. The digital language sets, also known as the relatively complete character sets, for each of the languages includes a number of characters or letters, punctuation marks and special characters of that language. Thus, the present server 104 stores the complete character sets of a large number of digitized or non-digitized languages, such as many regional languages and their local variations, in existence. The server 104 enables the users of the electronic devices 102 to remotely access and/or download the complete character sets of desired languages over a wireless communication network 106, for example. In some instances of the business method, the users can purchase the complete character sets of desired languages in form of an offline software package and can install in their electronic devices such as, but not limited to, computers for accessing the character sets of the desired languages. In another embodiment of the present business method, the server 104 may store about at least 2600 local and national languages and complete character sets of associated languages, and the users can access these character sets through their electronic devices 102, either by downloading to their electronic devices via the wireless communication network 106 or installing using an offline supplied software package.

In a another embodiment of the present invention, the server 104 may also store a number of interactive soft keyboards usage and operational data associated with each of the digital language sets corresponding to the regional languages and its local language variations stored in the server 104. These interactive soft keyboards are based on the unique keyboard layouts designed for each of the languages and stored in the server 104. According to one or more business method embodiment, the interactive soft keyboards based on the unique keyboard layouts designed for each of the languages and stored in the server 104 is made available to the electronic devices 102 such as, but not limited to, smartphones, tablets, wearable device and other smart devices in form of a mobile application, which the users can download from the application stores, such as, but not limited to, Apple App store, Google Play store, etc. In such instances, the interactive soft keyboard application running on the electronic devices 102 of the user communicates with the server 104 over a wired or wireless communication channel 106 to access the interactive soft keyboards associated with each of the digital language sets corresponding to the regional languages and its local language variations stored in the server 104. The interactive soft keyboard application running on the electronic devices 102 provides an interactive soft keyboard on the electronic devices 102, which may be based on a custom digital keyboard chart unique to each of the languages or the corresponding digital language set stored in the server 104. The interactive soft keyboard based on the custom digital keyboard chart or unique keyboard layout obtained from the server 104 allows the users to provide text information in his/her selected regional language and its local language variations. In some instances, the custom digital keyboard charts corresponding to the regional languages and its local language variations or corresponding digital language sets stored in the server 104 has a unique keyboard layout, which may be made as close to the arrangement of keys in a QWERTY layout or any other widely used keyboard layout.

It is noted, in one embodiment, that when using a keyboard chart there may be a physical layout (one large layout or singly placed on individual keys) to place over a physical keyboard that shows which key to actuate to enable the previous first language letter key to access a different second language letter key that is used in the selected second language. Thus, in other words, enabling a first language keyboard to be reconfigured to type in a different second language, but using the physical keys of the first language and typing in a different second language. For example, this is like using English language keys and potentially using or lying over the provided chart that shows which keys to use to get Arabic letters typed on the GUI or screen.

In another embodiment of the present business method invention, the custom digital keyboard charts corresponding to the regional second languages and its local language variations or corresponding digital language sets stored in the server 104, includes a number of characters or letters, a number of punctuations and a number of special characters unique to each of the regional language or corresponding digital language sets. According to one or more embodiments, the interactive soft keyboards based on the unique keyboard layouts designed for each of the languages and stored in the server 104 is made available to the electronic devices 102 such as, but not limited to, computers, and other computing devices in form of a standalone or offline software package or application, which the users can download from the server 104 through the cloud 106, or obtained in a CD, or thumb drive the language data set to install within the electronic device 102 of the user and a custom digital keyboard chart where appropriate.

The custom digital keyboard charts generally correspond to the regional languages and its local language variations or the corresponding digital language sets stored in the server 104 and installed in the selected electronic devices 102, which may be made to fit over and as close to the arrangement of keys in a QWERTY layout or any other widely used keyboard layout.

According to one or more embodiments, the interactive soft keyboards based on the unique keyboard layouts designed for each of the languages and stored in the server 104 is made available to the electronic devices 102 such as, but not limited to, feature phones, typewriters, keyboards etc. in form of a physical keyboard layout imprinted on the keys of the device 102. The custom digital keyboard charts corresponding to the regional languages and its local language variations or corresponding digital language sets stored in the server 104 and provided as physical keyboards to the users has a unique keyboard layout, which may be made as close to the arrangement of keys in a QWERTY layout or any other widely used keyboard layout.

In other embodiments envisioned herein, the key positions of each of the characters, punctuations or punctuations marks and special characters in the custom digital keyboard charts corresponding to a language or digital language set, i.e. the stored digital character set of the language, which are selected based on a general frequency of use of each of the characters, the punctuations and the special characters and a pronunciation or sound and shape of each of the characters in that particular language. The present system 100 and method for creating unique keyboard layouts for many regional languages and its local variations and providing unique keyboard layouts in an interactive soft keyboard form through the interactive soft keyboard application running on the electronic devices 102 has a wide variety of applications including applications in text messaging services, social networking, digital marketing, for use by service providers, medical providers, police services, application developers, electronic device manufacturers, printing and publishing companies, etc. The above said service providers and device manufacturers can obtain the unique keyboard layouts for many regional languages and its local variations as a standalone or offline software package, or from an application store as discussed above or as a physical keyboard with physical layout, enabling them to provide a variety of services to the users in the native language of each of the users.

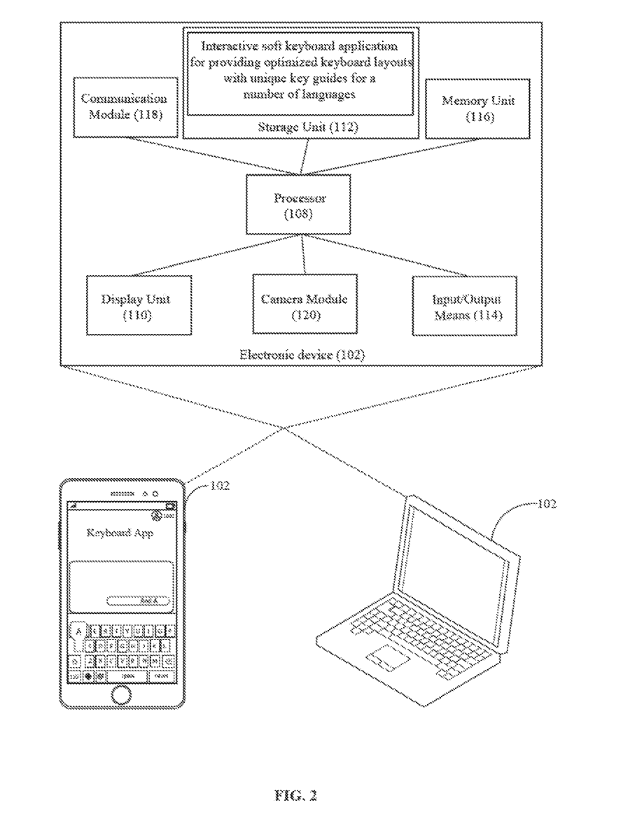

The hardware and software components of the present system 100 are discussed in detail below prior to disclosing the unique features and services offered by one or more embodiment of the present system 100. FIG. 2 is one embodiment of a block diagram showing different components and modules of the electronic device 102 running the interactive soft keyboard application enabling the users to provide text input through the interactive soft keyboard uniquely designed for a desired regional language selected by the user, according to a preferred embodiment of the present invention. The electronic device 102 can be any smart device such as, but not limited to, a smartphone, tablet, computer, smart wearable devices, and other smart devices or a computer connected to the Internet and capable of displaying a interactive graphical user interface (GUI) of the interactive soft keyboard application for enabling the users to provide text input through the uniquely designed interactive soft keyboard in a desired regional language selected by the user. The electronic device 102 includes a processor 108 to process a number of instructions of the interactive soft keyboard application, which enable the users to select a desired digital regional language or his/her native language(s) from a number of stored digital language sets or digital character sets corresponding to a large number of regional languages stored in the server 104. Further the electronic device 102 running the interactive soft keyboard application communicates with the the server 104 over the communication network 106 and allows the users to download or access a desired unique keyboard layout, corresponding to the selected regional language or his/her native language(s), for the interactive soft keyboard launched from the device 102. The electronic device 102 further includes a display unit 110 for displaying an interactive graphical user interface of the interactive soft keyboard application, a storage unit 112 for storing a variety of data including the interactive soft keyboards and associated data of the desired digital regional languages set by the user through the interactive soft keyboard application. Further an input/output means 114 allows the users to provide text data using the interactive soft keyboards displaying the characters of the selected regional language of the user. The electronic device 102 further includes a memory unit 116 for temporarily storing the data and instructions while performing a number of operations, including above said tasks, by the processor 108 based on the instructions of the interactive soft keyboard application. The electronic device 102 also houses includes a communication module 118 to enable communication between the electronic devices 102 and the server 104 via the communication network 106. The users are allowed to provide textual inputs in a desired regional language, which is selected by the user from the server 104, through the interactive soft keyboard presented through the interactive graphical user interface of a variety of applications using a keyboard, a pointing device such as a mouse, at least one gesture or touch, voice activation, or any other interacting means. The electronic devices 102 further include a camera module 120 to capture contents including images and videos and share the captured contents through the dynamic graphical user interface of many supported applications. Further, the input/output means 114 allows the users to respond or react to the contents presented to the users through the interactive graphical user interface of many applications using text, comments, pictures and text, videos and text or special characters such as, but not limited to, emojis and other symbols. In case of textual inputs, the present interactive soft keyboard application allows the users to provide text contents in the regional language set by the user. The text contents are provided through the interactive soft keyboard having a custom keyboard layout unique to the particular language or related languages pre-selected by the user.

In an alternate embodiment of the present invention, the electronic device 102 is a computer such as a personal computer or a laptop computer running on platforms such as, but not limited to, Windows, Mac etc. For such electronic devices 102, the present system 100 allows the users to download the desired digital language sets or the complete character sets of desired languages from the server 104. The users may be provided with a web interface for selecting and downloading the desired digital language sets or the complete character sets of desired languages from the server 104. The users are also allowed to download the interactive soft keyboards based on unique keyboard layouts for each of the selected language sets, which can then be installed into the electronic device such as the computer 102. The users are also provided with necessary guides or instructions on how to use the keyboard and the keys or trigger keys for activating one more special character present in the interactive soft keyboards or the unique keyboard layouts. The users can also purchase the desired digital language sets or the complete character sets of desired languages and the interactive soft keyboards based on unique keyboard layouts for each of the selected language sets as standalone software packages, made available in optical or other storage devices. The users can install the interactive soft keyboards based on unique keyboard layouts for each of the selected language sets in their electronic devices or the computer 102 and can provide textual inputs in the selected language through the interactive soft keyboards displayed on the display unit 110 of the device 102.

In another embodiment of the present invention, the electronic device 102 is a feature phone or a keyboard used with other electronic devices for providing textual inputs. In such cases, the device manufacturers can obtain the desired digital language sets or the character sets and the unique keyboard layouts for the desired language from the server 104. Based on the unique keyboard layout, the device manufacturers can imprint the keys with the appropriate characters, or punctuations marks or special characters of the selected language. The users can select the desired device 102 with his/her language of choice. Hence the present system allows the users from all over the world, to type in their native languages using the unique keyboard layouts made available to them though their electronic devices.

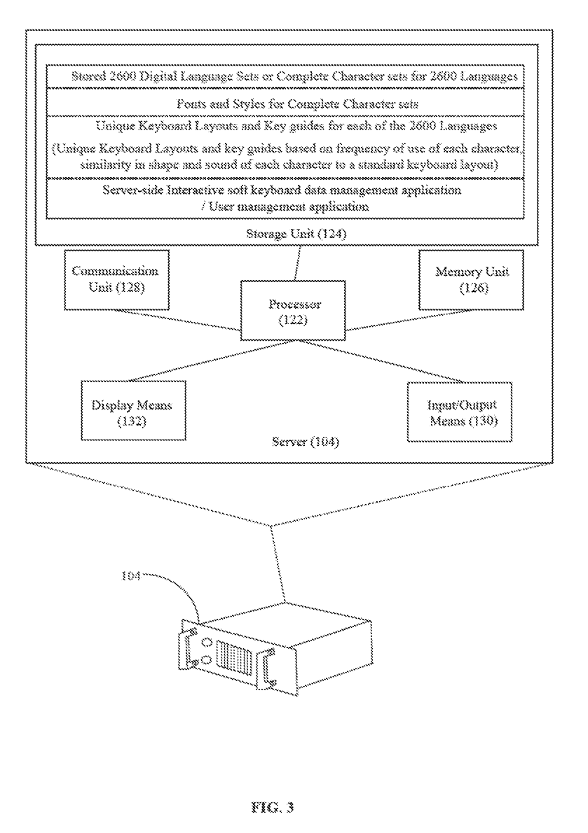

FIG. 3 is one embodiment of a block diagram showing the different components and modules of the server 104 in communication with the electronic communication devices 102 running the present application, according to a preferred embodiment of the present invention. The server 104 can be a physical server 104 located at one or more locations or a central cloud server 104 offering services to the users via the application connected to the central cloud server 104. The server 104 can be used to create and store the digital language sets or the complete character sets of many languages including the regional and local variations of these regional languages in a number of steps. The optimal and ergonomic keyboard layouts for each of the languages are identified in a number of steps based on the frequency of use of each of the characters and similarity in the shape and size of each of the characters with the characters of an already established keyboard layout, such as the QWERTY English keyboard layout. The server 104 stores the complete character sets of all the languages and the unique keyboard layouts for each of the languages. Further the server 104 also stores the fonts and styles supported by each character sets of the languages. The authorized electronic device 102 can access the stored data over the wireless communication network 106, such as Wi-Fi enabled Internet connection. In some other instances, the server 104 runs a server-side keyboard interactive soft keyboard data management application, which is in communication with the interactive soft keyboard application running on the electronic devices 102 of the users over the wireless communication network 106. In such instances, the server-side keyboard interactive soft keyboard data management application manages the connections or users connecting to the server 104 using the interactive soft keyboard application running on their electronic devices 102.

The server 104 includes similar components as any normal server or a computer, which includes a processor 122, a storage unit 124, a memory unit 126, a communication unit 128, an input/output (I/O) means 130 and an optional display means 132. The server 104 communicates with the electronic devices 102 in real-time, over the Internet, enabled by the communication unit 128. In some instances, the server 104 is installed with a user management application configured to manage the operations of the users of the present interactive soft keyboard application. In certain embodiment, the users can register into the user management application running on the server 104 for selecting the desired language sets or the unique keyboard layout for those languages sets. In some other instances, the users can register into the user management application running on the server 104 through a web interface to select, make payment and download the desired unique keyboard layouts for the desired languages of the user. The user management application manages the user account and keeps track of the user's activity with the server 104 and the data, such as the keyboard layouts and the digital language sets or character sets of desired languages selected by the user. The users can also utilize the user management application running on the server 104, which includes a number of interactive soft keyboard or unique keyboard layouts for one or more regional languages, to purchase or request the desired character set of a language and the unique keyboard layouts of the language with the available font and other styles supported by the font. In some instances, the users can purchase or request the desired character set of a language and the unique keyboard layouts of the language with the available font and other styles supported by the font through a web platform or browser launched from the electronic device 102. The user management application is stored in the storage unit 124 and the processor 122, when required, executes the instructions of the user management application. The memory unit 126 stores the data associated with the user management application when the processor 122 executes the instructions of the application. The user management application includes a user management module that handles all the information related to the user registration and all other user related activities performed by the users, such as providing text inputs in a desired language through a unique interactive soft keyboard layout made available to the user through the user's electronic device 102. The user management application running on the server 104 further includes a content management module that receives and temporarily or permanently stores the contents, such as the character sets, unique keyboard layouts, font and styles of one or more selected languages by the user, to be presented or stored in the electronic device 102 for allowing the users to provide textual inputs in the desired regional language using the interactive soft keyboard having the keyboard layout unique to the particular regional language chosen by the user.

In certain embodiment, as described above, the present interactive soft keyboard application is made available to the users in form of a mobile application or a smartphone application and the users can download the interactive soft keyboard application from Internet sources including, but not limited to, iTunes store or App store, Google play store and many other software stores and install the application in their electronic devices 102 such as Smartphones. In some instances, different versions of the present application are available from the Internet sources, each version is configured to optimally run on different electronic devices 102 such as tablet, smartphone, smart wearable device, computers etc., and the users can select and download the desired versions of the interactive soft keyboard application into their electronic device 102. After downloading and installing the interactive soft keyboard application, the users can launch the application from the electronic device 102 and view the interactive graphical user interface including one or more interactive soft keyboards having unique keyboard layouts for one or more languages selected by the user. The interactive soft keyboard application allow the users to perform a number of tasks such as, but not limited to, search for desired digital language sets or character sets for a number of languages stored in the server 104, download unique keyboard layouts for the desired languages stored in the server 104, texting in a preferred regional language through the interactive soft keyboard layout having the unique keyboard layouts and key guides for accessing one or more characters of the language, etc.

The present computer-implemented system 100 and the method for allowing the users to provide text inputs in a desired language selected by the user using their electronic devices 102 includes three main steps such as, at first, digitizing most of the available languages currently in existence by creating complete character sets of each of these languages and storing them in the server 104, followed by creating unique keyboard layouts and Key guides for each of these languages and providing these unique keyboard layouts to the users. The unique keyboard layouts for each of the languages, stored in the server 104, is made available to a wide variety of consumers or users through a number of ways, which are discussed in the following sections.

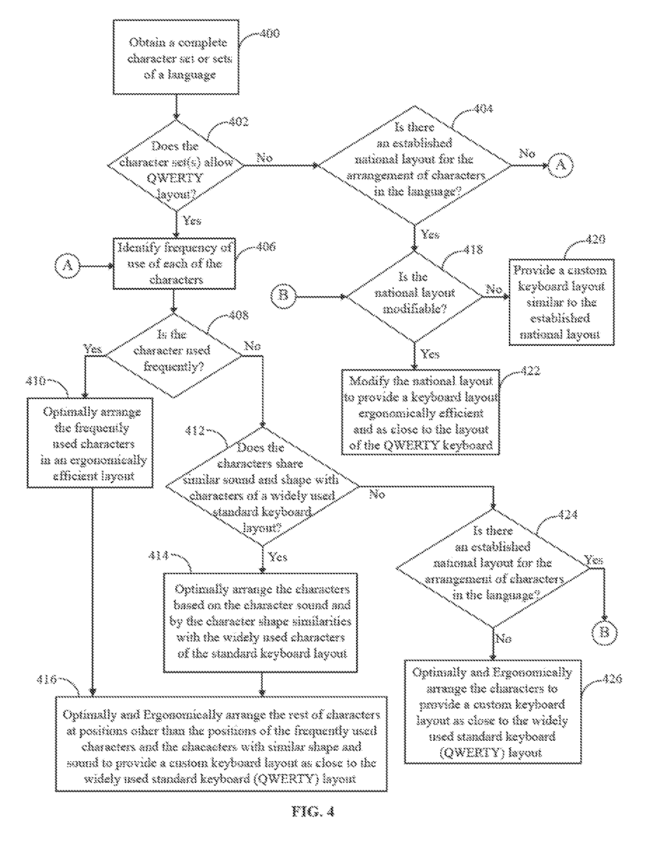

FIG. 4 is one embodiment of a flowchart showing potential steps for creating the unique interactive soft keyboards based on the custom keyboard layouts for each language, according to a preferred embodiment of the present invention. The present method can be used to create custom keyboard layouts for a wide variety of languages including many regional languages and local variations of these languages, which may or may not have a digital character set or sets. In order to create custom keyboard layouts for each of the languages, first the complete character set(s) of each of the languages are identified, as shown in block 400. The complete character set(s) of a language includes all the characters or letters in the language, the punctuation marks and all the special characters including various types of spaces in that language. Currently there are more than 3000 widely used languages, which includes many regional languages and local variations of these languages, having some or no digital presence. These languages include many Latin-scripts based languages, non-Latin alphabetic scripts based languages, and other language forms having a definite script or character set. The present invention stores the complete character set(s) of up to or more than 2600 languages including many regional languages and local variations of these languages used around the world in the server 104. Thus the digitally available complete character set(s) of up to or more than 2600 languages can be included in a linguistic software, which the users can utilize to access the character set(s) of their desired language from their electronic devices.

The complete character set(s) of each of the languages stored in the server 104 can further be utilized for creating unique or custom keyboard layouts for each of these languages. The custom keyboard layouts for each of the languages can be utilized by many applications running on electronic devices 102 such as, but not limited to, smartphones, tablets, wearable devices etc. to enable the users to type or text in a desired language using the custom keyboard layout of that particular language presented to the users through a user interface of the electronic device 102. The custom keyboard layouts for each of the languages can also be utilized by other hardware devices such as, but not limited to, keyboards, feature phones or phones having a physical keyboard, and other electronic devices assisting in typing or texting. These devices can utilize the custom keyboard layouts for the desired languages by imprinting the characters, punctuation marks and the special characters on the physical keys of the device, which allows the users to type or text in that language using these devices.

Further, the blocks 402 to 426 represent a series of steps for creating custom keyboard layouts for each of the languages, including many regional languages and local variations of these languages, with their digital character set(s) stored in the server 104, according to one or more embodiment of the present invention. Prior to designing the keyboard layouts for each of those languages stored in the server 104, a number of standard keyboard layouts are identified. These standard keyboard layouts are widely in use in many languages including English, Arabic, Indian, Chinese, etc. These standard keyboard layouts generally falls under the widely used keyboard layout designs, such as, but not limited to, standard QWERTY-based Latin-script keyboard layouts, standard non-QWERTY-based Latin-script keyboard layouts and other established national keyboard layouts.

In the next step, according to some embodiment, the languages having same or similar characters set(s) such as, same or similar characters or letters, punctuation marks, special characters etc., are identified among the languages stored in the server 104. At first, the complete character set(s) of a first language, which can be a desired regional or native language, local variations of the regional language of a user and associated languages sharing the same or a part of the character set(s) of the first language, is identified and stored in the storage unit 124 of the server 104 for further processing using the processor 122 in communication with the memory unit 126. Now, the custom keyboard layout for the first language and the associated languages is created in a number of steps as discussed below. First, in order to create the custom keyboard layouts for the first language and the associated languages, the compatibility of the character set(s) of the first language and the associated languages with the standard QWERTY keyboard layout is identified, as in block 402. If the complete digital character set first language and the associated languages stored in the storage unit 124 of the server 104 supports the QWERTY keyboard layout, then each of the characters, punctuation marks and the special characters in the characters sets of the first language and the associated languages are analyzed for its frequency of usage in that particular language, especially during scripting of the language, as shown in block 406. Now, the frequently used characters in the first language and the associated languages, verified in step 408, are arranged in an ergonomically efficient layout similar to the layout of characters in the QWERTY layout, as shown in block 410. The characters, the punctuation marks and the special characters in the first language and the associated languages, which are not frequently used and thus not arranged in the above step, are analyzed for similarities in sound or pronunciation and shape with the characters of a widely used language such as, but not limited to, English, and having a standard keyboard layout, i.e. the QWERTY layout, as in block 412. The character(s) of the first language and the associated languages with similar sound or shape as the character(s) of the widely used languages, such as, but not, limited to, English, using the QWERTY keyboard layout, takes the appropriate positions in the QWERTY keyboard layout, as in block 414. Now as in block 416, the rest of the characters, punctuation marks and the special characters in the first language and the associated languages, which are not arranged in the above two steps, are optimally and ergonomically arranged on the custom keyboard layout to form a keyboard layout as close to the widely used standard keyboard layout, such as the QWERTY layout. The newly created custom keyboard layout(s), for the first language and the associated languages, similar to the QWERTY layout enables easy access to each of the characters, in the first language and the associated languages, by the users who are familiar with the QWERTY keyboard layout, during texting or typing.

In some instances, the character set(s) of the first language and/or the associated languages do not support the QWERTY keyboard layout. In such instances, the present method checks whether the character set(s) of the first language and/or the associated languages has an established national keyboard or typing layout in use, as in block 404. If the first language and/or the associated languages do not have a national keyboard layout, then the characters, punctuation marks and the special characters in the character set(s) of the first language and/or the associated languages are arranged following the steps from 406 to 416 as described above. However, if the character set(s) of the first language and/or the associated languages supports a national keyboard layout, then the present method of forming the custom keyboard layouts for the first language and the associated languages, checks whether the national keyboard layout for the character set(s) is modifiable to form a more convenient and ergonomically efficient custom keyboard layout, which is as close to the keyboard layout of the widely used standard keyboard layout, such as the QWERTY layout, as in block 418. If the arrangement of characters of the established national keyboard layout is modifiable, then a custom keyboard layout is formed by modifying the positions of the characters, punctuation marks and the special characters in the particular language in the established national keyboard layout, to form a more convenient and ergonomically efficient custom keyboard layout, which is as close to the keyboard layout of the widely used standard keyboard layout, such as the QWERTY layout, as in block 422. The custom keyboard layout thus formed includes the complete character set(s) of the first language and/or the associated languages and provides a more convenient keyboard layout for the native speakers of that language and others following the QWERTY keyboard layout. In some instances, the character set(s) of the established national keyboard layout is not modifiable, without largely disturbing the arrangement of characters in that national keyboard layout. Then the present method maintains the national keyboard layout of that particular language or provides a custom keyboard layout with minimal or zero modifications to the positions of the characters in the established national layout, as in block 420.

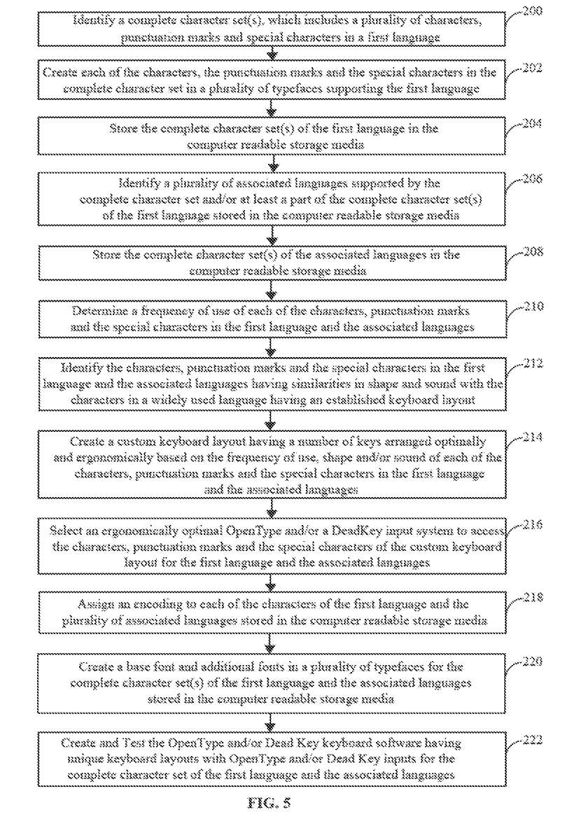

The present computer-implemented system 100 and associated method allow the users to provide the text inputs in a number of regional languages and local variations of these languages through custom keyboard layouts, created for each of these languages, using their electronic devices 102. These languages include many digitalized languages having their digital character set(s) stored in the server 104 or non-digitized languages without a digital character set. In case of non-digitized regional languages and its local variations, as discussed above, the present invention further proposes a computer-assisted method for creating a digital character set first and storing the digital characters sets(s) in the server 104. The present system 100 and method can further be utilized to create the interactive soft keyboard(s) for each of the digital character set(s) and store it in the server 104 for allowing the users to access the unique digital character set(s) and the keyboard layout(s) through the interactive soft keyboard application launched from the electronic device 102 of the user, using electronic devices 102 having physical keyboards designed based on the unique keyboard layouts and through other texting and typing applications launched from other electronic devices. FIG. 5 is a flowchart showing the steps of the computer-assisted method for creating a digital character set(s) of existing digitized and non-digitized languages including many regional languages and local variations of these languages and thereafter forming a unique interactive soft keyboard layout for each of these languages, according to a preferred embodiment of the present invention. According to certain embodiment, the unique interactive soft keyboard layouts formed using the present method for each of the languages, including many of the regional languages and local variations of these languages around the world, is made available to the users in form of a computer program product. The users can readily access the unique interactive soft keyboard layouts for desired languages through the interactive soft keyboard application running on the electronic devices 102 of the users, according to one or more embodiment of the present invention. The present computer-assisted method includes the initial steps of identifying the non-digitized regional languages and local variations of these languages, without a digital character set in place for representing the characters of the each of these languages digitally for texting and other printing purposes. At present, there are only a handful of languages including many regional languages and local variations of these languages represented using a digital character set and made available to the users through the various electronic devices 102 such as computer, smartphones, tablets, wearable devices etc. The present computer-assisted method assists the users to create digital character sets and custom keyboard charts having unique key guides for over 2600 languages including many regional languages in the Asian, African, European and American regions.

The present computer-assisted method starts with identifying a complete character set in the first language as in block 200. The complete character set of the each of the languages including the first language includes a number of characters, a number of punctuation marks and a number of special characters. Now as in block 202, each of the characters, the punctuation marks and the special characters in the complete character set(s) of the first language are created in a number of typefaces supporting the first language. After creating the complete character set(s) of the first language in the desired typefaces, all the characters, the punctuation marks and the special characters in the complete character set(s) of the first language are stored in the computer readable storage media, which can be the storage unit 124 of the server 104, as shown in block 204. Now, as in block 206, a number of associated languages supported by the complete character set(s) or a part of the complete character set of the first language stored in the computer readable storage media is identified. In the above steps, the users can create the complete character set(s) for each of the languages, which include both digitized and non-digitized languages around the world, and then, as in block 208, the complete character set(s) and one or more supported typefaces are stored in the computer readable storage media, which can be the storage unit 124 of the server 104. Now, in order to form a layout of characters, punctuation marks and special characters in a custom keyboard chart, the frequency of use of each of the characters, punctuation marks and the special characters of the first language and the associated languages are determined, as shown in block 210. After identifying the frequently used characters in the first language and the associated languages, the shape and sound of characters, the punctuation marks and the special characters in the first language and the associated languages are compared with the shape and sound of characters, punctuation marks and special characters in a widely used language, such as, but not limited to, English, having an established keyboard layout, such as, but not limited to, QWERTY layout, as in block 212. After the above stated steps, a custom keyboard layout having a number of keys optimally and ergonomically arranged based on the frequency of use, shape and/or sound of each of the characters, the punctuation marks and the special characters in the first language and the associated languages is formed, as in block 214. Now, in order to access the characters, punctuation marks and special characters of the custom keyboard layout(s) formed in the above step, an ergonomically optimal OpenType and Dead Key input system is selected, as in block 216. The selection and arrangement of keys in the OpenType and Dead Key input system, representing each of the characters, punctuation marks and special characters of the first language and/or the associated languages, is based on a number of factors including the frequency of use of each of the characters, punctuation marks and the special characters, sound or pronunciation and shape of each of the characters, punctuation marks and the special characters and intuitiveness and ergonomics of the keys for that particular language. In addition, the arrangement of keys in the OpenType and Dead Key input system, representing each of the characters, punctuation marks and special characters of the first language and/or the associated languages, is also based on the closeness or similarities in their arrangement and accessibility to the widely established preferred standard keyboard layout, such as the QWERTY keyboard layout.

In certain embodiment, the Dead Key input(s) for accessing one or more characters, punctuation marks and the special characters of the first language and/or the associated languages is required for applications, launched on the electronic device 102, that do not have sufficient OpenType support to use the OpenType keyboard. A “Dead Key” is a key that is designated as a trigger key, which when typed alone nothing happens, but as soon as the next key is typed, it calls up the composite character designated for that combination. For example, in the “Dead Key” for LaserGreek in Unicode, the “j” key is the trigger for the smooth breathing mark. Typing “j a” calls up the composite character in the font containing the alpha with a smooth breathing mark over it. Typing shift-J calls up the composite character in the font containing the alpha with a rough breathing mark over it. The LaserGreek ASCII fonts for both Macintosh and Windows designate the “j” key as an overstriking character, so no matter what vowel is typed before it, the smooth breathing mark will overstrike that vowel, putting the smooth breathing mark over it. Using the present method, if the first language and/or the associated language's character set(s) are based on the Latin alphabet, then the present method can be utilized to provide a keyboard layout that corresponds as closely as is ergonomically efficient to the QWERTY layout. In case, if there is an established national layout for the arrangement of characters of the first language and/or the associated languages that is different from the QWERTY layout, then the present method prefers the keyboard layout national layout of the characters of the particular language, as described in FIG. 4. In some instances, a modification of the national layout of the keyboard, which is efficient and ergonomic and as close to the layout of the QWERTY keyboard that supports a more complete character set of the first language and/or the associated languages is created and stored in the server 104. In some instances, the first language and the associated languages is alphabetic and the present method can further be utilized to provide a custom keyboard layout on a modification of the QWERTY keyboard that is as intuitive as possible, if possible by the character sound or by the character shape. For example, in a custom keyboard layout based on a modification of the QWERTY keyboard, the corresponding keys are assigned based on the similarity in sound or pronunciation, such as, Greek upsilon is assigned on the U key, the Greek phi on the F key, the Greek chi on the C key, and the Greek xi on the X key, based on the sound of the character. In some other instances, there may not have any available keys in the QWERTY keyboard that resembles the sound of certain characters in the desired language, in such cases, the shape of the characters in that particular language is compared with the characters on the QWERTY keyboard to select a suitable key for representing the character of the desired language. For example, the Greek letters psi is assigned to the Y key, omega is on the W key and the theta is on the Q key based on the similarity in shapes of these characters in both languages. In addition, some keys representing one or more characters, punctuation marks and special characters of the first language and/or the associated languages are conveniently placed on the unique keyboard layout for easy access. For example, the J key is not used in Greek but is on the QWERTY keyboard that is easiest to type or reach, which is positioned in the home row right hand index finger, hence can be used for the most common diacritic, the smooth breathing mark, and ‘shift’ J for the rough breathing mark. Since the V key is not used in Greek but is conveniently positioned on the QWERTY keyboard for easy access with the index finger of the left hand, the V key can be used to type the acute accent, which is the most commonly typed Greek accent.

After selecting the desired custom keyboard layout for each of the languages including the first language and the associated languages, an encoding is assigned to each of the characters of the first language and the associated languages represented on the custom keyboard layout and stored in the computer readable storage media or in the server 104, as in block 218. In some instances, each characters of the custom keyboard layout for the first language and the associated languages has an already established Unicode encoding, which can directly be utilized for typing or texting using the character set(s) of the particular language, i.e. the first language and/or the associated languages represented by the custom keyboard layout. In some instances, the Unicode established encoding of a particular language might not be supported in one or more applications. In such instances, the present system 100 and associated method provides both the Unicode established encoding and a separate encoding for the complete character set(s) of the particular language to enable typing and texting from both the Unicode unsupported applications and Unicode supported applications. In a preferred embodiment, the present system 100 and method provides an ASCII or ANSI encoding for the complete character set(s) of many languages so that the language can be typed in non-Unicode compliant applications launched from the electronic device 102 of the users. In some other instances, the present system 100 and method provides Indian Standard Code for Information Interchange, ISCII encoding, for the complete character set(s) of regional Indian languages that originate from Brahmi script. Unlike Unicode, ISCII is an 8-bit encoding that uses escape sequences to announce the particular Indic script represented by a following coded character sequence. Thus the present system 100 and method enables the users to access the complete character set(s) of a desired language, such as, the first language and the associated languages, in a number of Unicode complaint and non-Unicode complaint applications configured to run on the electronic devices 102 of the users.

After creating proper encoding for the character sets in all the languages, including many regional languages and local variations of these languages, to enable the characters to be represented in the unique custom keyboard layouts, a base font is created for the complete character set(s) of each of the languages, as shown in block 220. The method of creating the base font includes the steps of creating font character parameters and outlines for each of the characters, which includes the mathematical description of all the lines and curves that compose each character and making sure there are no overlapping paths in the lines and curves that compose each character. In a preferred embodiment, the present system 100 and method creates both ASCII/ANSI font and a Unicode-encoded font for the complete character set(s) of each of the languages stored in the server 104. In some instances, the unmodified US keyboard layout cannot ergonomically support the base font created for the complete character set(s) in the selected language, such as, with the newly created font family such as, but not limited to, LaserGreek, LaserHebrew, and LaserUgaritic ASCII/ANSI fonts for Macintosh operating system. In such instances, the present system 100 and method creates OpenType and Dead Key keyboard software for Macintosh and for Windows operating systems following the specifications determined in step described in block 216. In some instances, Visual OpenType Layout Tool (VOLT) tables are used to add to the font whatever OpenType features are required for the character set of the particular language. The VOLT provides an easy-to-use graphical user interface to add OpenType layout tables to fonts with TrueType outlines.

In a next step shown in block 222, the OpenType and Dead Key keyboard software having the unique keyboard layouts with OpenType and Dead Key inputs for the complete character set(s) of each of the languages including the first language and the associated languages are tested using selected applications such as, but not limited to, Microsoft Word and Mellel for Macintosh OpenType fonts, to make sure that the keyboard software works properly with the new base font to produce the correct character(s), all composite characters, all characters with one or more diacritic mark(s), and all conjunct characters or syllabary characters in the case of languages like LaserAmharic that use a syllabary, not an alphabet.

Once the characters are laid out in the unique keyboard layout and fonts are created and tested in actual texting and typing software running on different platforms, additional styles including bold, italic, bold-italic and typeface families are added to the OpenType and Dead Key keyboard software for modifying the base font and additional fonts for the complete character set of each of the languages including the first language and the associated languages. For Latin-based languages, the present method provides Times-style, Helvetica-style, Garamond-style, Palatino-style, Zapf Chancery-style families of fonts and in some instances Courier-style and Helvetica-condensed families of fonts. Further, the present method creates macros that convert ASCII/ANSI text into Unicode encoded text, or CrossPlatform Converter macros that unscramble ASCII/ANSI text that is opened on a different platform such as Windows or Macintosh than it was created. Since Windows and Macintosh follow different Latin 1 encoding standards in which only 5 of the 128 upper ASCII characters have the same encoding, and the typing application such as Microsoft Word assumes that all ASCII/ANSI text coming from a different platform is Latin 1 text, it automatically changes the encodings of all but 5 of the 128 upper ASCII characters in ASCII fonts. The present CrossPlatform Converter macros return each letter to its proper ASCII/ANSII encoding for that language eliminating the above problem for all types of platforms including Windows and Mac.

In a final step, keyboard charts are created for each unique keyboard layout(s) supported by the font. Most of the newly created Unicode-encoded fonts include all the Latin 1 characters in addition to the characters, punctuation marks and special characters in the unique keyboard layout for the specific language(s) those fonts support. Hence, the present system 100 and method provides keyboard charts for the language(s) that the application supports and an ergonomic OpenType and Dead Key keyboard software that permits typing all Latin 1 languages from a single unique keyboard or custom keyboard layout of the particular regional language. The interactive soft keyboard based on the custom keyboard chart or custom keyboard layout having the OpenType and Dead Key inputs for the complete character set(s) of each of the languages including the first language and the associated languages is made into a package capable of being executed by the processor 108 associated with the electronic devices 102. The package also includes a user's manual that explains how the software works for that language for easy understanding and other ReadMe file and/or other supplemental files that identify changes in upgrades or new instructions for things for activating keyboards in new operating systems or OpenType support. In some instances, the package also includes a master file with all the component parts of the product and either an installer or installation instructions that can be downloaded from a website, cloud storage, as a mobile or web application or shipped on a disc. In one or more embodiment, the mobile application is called the interactive soft keyboard application, which allows the users to download and install an interactive soft keyboard having a custom keyboard layout of a selected language. This enables the users to text and type in their native languages using their electronic devices 102 such as the smartphone, tablet, computer, etc.

The present computer-implemented system 100 and method enables the users to access the unique keyboard layouts for more than 2600 languages, with their complete character set(s) stored in the server 104, according to one or more embodiment of the present invention. The unique keyboard layouts for all the languages, including the 2600 languages stored in the server 104, is made available to the users in a number of ways such as, but not limited to, in form of a mobile or smartphone application that can be installed on the smart electronic devices 102 of the users such as, smartphone, tablet, wearable device etc., in form of a software application capable of being installed on all the computers or laptops running on operating systems including Windows and Mac, and in form of unique keyboard layouts that can be imprinted or incorporated onto the physical keyboards of the electronic devices 102 such as, the feature phones, keyboards, and other devices having electronic physical keyboards.

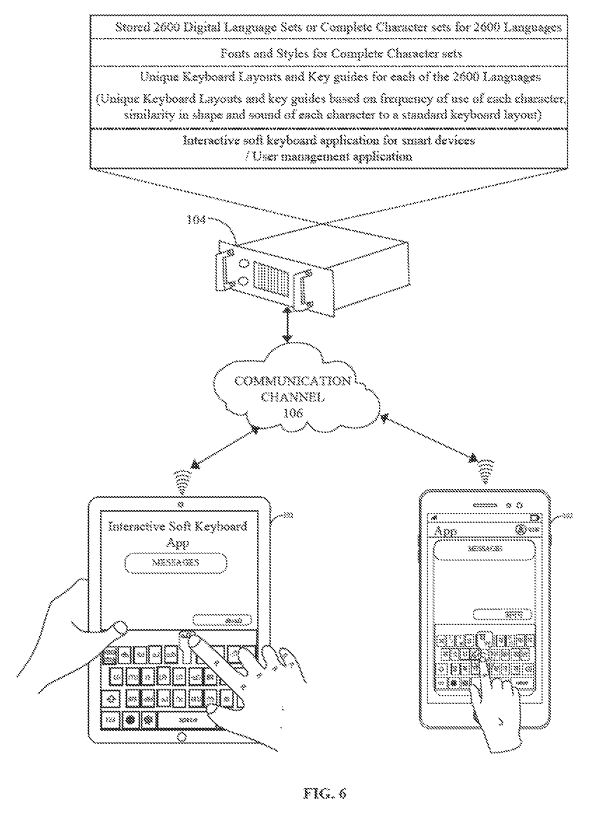

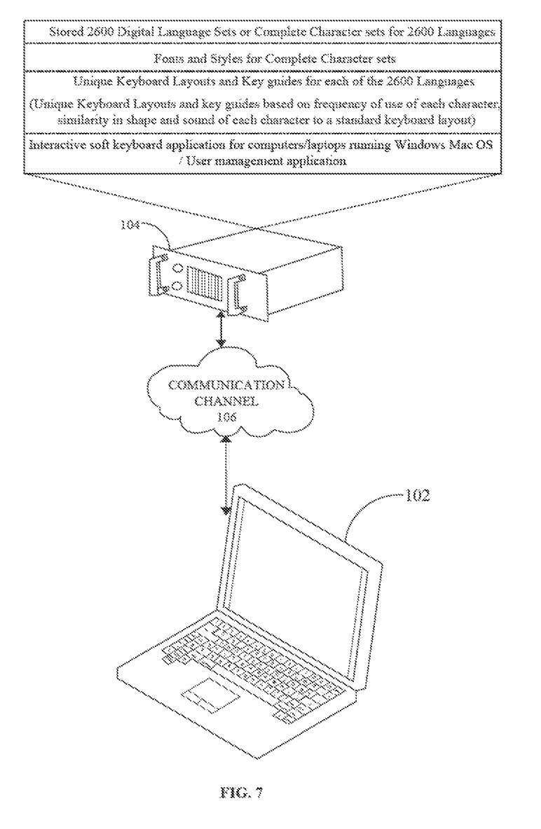

FIG. 6 illustrates a computer-implemented system 100 involving the electronic devices 102 for allowing the users to access the unique keyboard layouts for all the languages stored in the server 104 to provide text inputs in a number of languages through the interactive soft keyboards displayed on the smart electronic device 102 of the user, according to an embodiment of the present disclosure. The users can download the interactive soft keyboard application from the server 104 directly via an online link or from Internet sources including, but not limited to, iTunes store or App store, Google play store and many other software stores and install the application in their electronic devices 102 such as Smartphones. FIG. 7 illustrates a computer-implemented system 100 involving electronic devices 102 such as a laptop or a computer running on an operating system such as Windows or Mac for allowing the users to access the unique keyboard layouts for all the languages stored in the server 104 to provide text inputs in a number of languages through the interactive soft keyboards displayed on the electronic devices 102, such as the computer, of the user, according to an embodiment of the present disclosure. The users can download the interactive soft keyboard application, which is configured for running on the computers having an operating system such as Windows or Mac, from the server 104 directly via an online link or from a website or from online storage devices or from other Internet sources including software stores and install the application in their electronic devices 102, such as computer. The interactive soft keyboard application running on the electronic devices 102 of the users, according to the preferred embodiment of the present invention, allows the users to download the interactive soft keyboards or the unique keyboard layouts corresponding to one or more regional languages and its local variations into their device 102. The instructions of the interactive soft keyboard application, when executed using the processor 108, provides interactive soft keyboards based on the custom keyboard layouts corresponding to the selected language within a graphical user interface of the electronic device 102 such as the smartphone. The interactive soft keyboards displayed within the graphical user interface of the electronic device 102 allows the users to access the characters, punctuation marks and special characters of the desired language represented by the custom keyboard layout for that particular language using the pointing devices such as a mouse, touch pen, at least one gesture or touch, voice activation, or any other interacting means. The users can further use the pointing device to activate the trigger keys or Dead Keys for accessing one or more characters punctuation marks and special characters of the selected language. According to one or more embodiment of the present system 100, the interactive soft keyboard application running on the electronic devices 102 allows the users to enlarge either a specific portion or a specific key on the interactive soft keyboard or the unique keyboard or keyboard chart uniquely designed for representing the character set(s) of many regional languages and its local variations. Further, one or more embodiment of the present system 100 discloses unique ways of accessing the specific portion or a specific key on the interactive soft keyboard or the unique keyboard or keyboard chart uniquely designed for representing the character set of many regional languages and its local variations. One or more unique ways of accessing the specific portion or a specific key on the interactive soft keyboard is disclosed below.

In one embodiment, when the pointing device such as the mouse, touch pen, at least one gesture or touch, voice activation, or any other interacting means is moved over a specific key or specific portion of the keyboard, enables the interactive soft keyboard displayed on the electronic devices 102 to enlarge the specific key or the keys around the specific key. In some other instances, moving the pointing device over the specific portion of the interactive soft keyboard enlarges the specific portion of the keyboard allowing the users to access all or the desired characters, punctuation marks and special characters, which are part of the character set(s) of a regional language or a local variations of the language created using the steps disclosed in FIG. 4, assigned to the keys in that specific portion or area of the interactive soft keyboard.

For example, in computers, when the mouse pointer is moved over the specific key or specific portion of the interactive soft keyboard, each character, punctuation marks and special characters of a particular language represented by the character set(s) in the interactive soft keyboard, gets magnified, allowing the users to access the desired character, punctuations and special characters of that particular language. In some instances, the proximity of fingers of the user, which acts as the pointing device on the touch screen of the electronic device 102, magnifies the specific key or specific portion of the interactive soft keyboard, each character, punctuations and special characters of a particular language represented by the character set in the interactive soft keyboard, allowing the users to select a desired character, punctuations and special characters of that particular language. In some instance, the proximity of fingers of the user near an individual key on the keyboard chart or the interactive soft keyboard displayed through the touch screen of the electronic device 102, magnifies all the four characters that the base font or fonts created, for each language using steps discussed above, typically provide for each key. Then the user can touch the desired character from the interactive soft keyboard through the touch screen display.

In some other embodiment of the present system 100, the interactive soft keyboard with the unique keyboard layout for a particular language presented to the users through the touch screen display of the electronic device 102, allows the users to use another key on the keyboard to enlarge specific keys on the keyboard layout presented through the touchscreen display. For example, the users can press the any of the keys such as, shift, control, alt, command, or option, so that when any of the above keys is pressed down, any key that is touched or pointed or activated using gesture or a touch becomes enlarged. In some instances, the control button in the QWERTY type or other forms of keyboard layouts created using the above-discussed methods is used to enlarge a specific key, representing one or more characters in the selected language, through the touchscreen display of the electronic device 102. The use of control key or any other designated key as a trigger or Dead Key that allows the users to access the specific keys with one-handed usage of the electronic device 102 such as smartphone or tablet. This method is especially suitable for accessing the desired character(s) from the enlarged keys in a computer as the typical keyboard for the computer includes Control button on both sides, irrespective of the platform it is running.

According to another embodiment, the interactive soft keyboard application running on the electronic devices 102 allows the users to use the keys, such as shift, control, alt, command, or option on the unique keyboard chart for a particular language, created using the above discussed methods, as triggers that enlarge each of the four quadrants of the interactive soft keyboard so that every key in the quadrant is large enough for the user to tap any of the four character or glyph options on that key. For example, pressing a preset trigger key activates the keys in the four quadrants including the left half top 2 rows of keys, right half top 2 rows of keys, left half bottom 2 rows of keys and right half bottom 2 rows of keys of the interactive soft keyboard. This enables the users to easily access the frequently used characters, punctuations and special characters of the specific language with the unique keyboard chart or layout created using the above-discussed methods.

According to another embodiment, the interactive soft keyboard application running on the electronic devices 102 allows the users to type on the unique keyboard chart, displayed on the electronic device 102, exactly like they do to type LS fonts on a computer keyboard. The users typically have four options for each key on the keyboard. In a first option, the users can tap any key to get the base letter. When the user presses the shift key and any specific key, he/she can get a first alternate character, punctuation mark or special character specific to that particular language and a capital letter in Latin based keyboards. When the user presses the option key on a Mac, or control-alt or right-alt key in Windows with any key on the unique keyboard chart or the interactive soft keyboard to get the third alternate character, punctuation or special character specific to that particular language.

The interactive soft keyboard for each of the plurality of languages presented to the users through the electronic device 102 includes the unique keyboard layouts for a number of regional languages including Asian, African, European and American regional languages and local variations of these languages, which are not incorporated in the existing OpenType keyboard formats. Further, the interactive soft keyboard application launched from the electronic device 102 allows the users to obtain the interactive soft keyboard having unique keyboard chart or keyboard layout for each of the languages from the server 104 over the communication network 106. In addition, the interactive soft keyboard application allows the users to download a desired interactive soft keyboard corresponding to desired languages from the server 106 to provide the text inputs through an input means, such as the pointing device, of the electronic device 102. The complete characters, punctuation marks and the special characters in the interactive soft keyboard is accessible to the users through a display means of the electronic device 102 using the pointing means selected from a group consisting of pointing devices such as mouse, touch or gesture on the touch screen display of the electronic device 102. One or more of the characters, the punctuations and the special characters corresponding to the selected languages in the interactive soft keyboard is accessible using the preset OpenType and Dead Key inputs. In some instances, the present system 100 includes OpenType programming that automatically selects the proper positioning for any accent with any letter, selects the proper conjunct form, changes normal sigmas to final sigmas, etc. Since most of the electronic devices such as the smartphones 102 supports OpenType programming, the need for the additional keystrokes is greatly reduced using the present method.

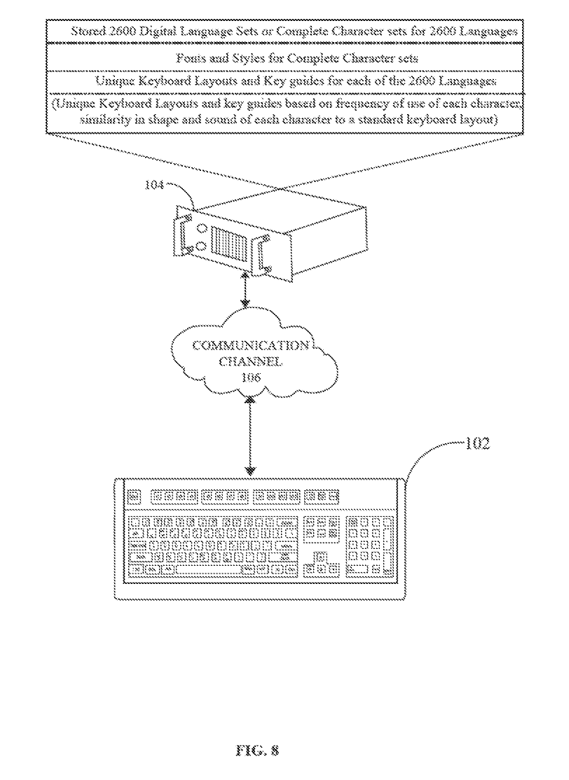

The present computer-implemented system 100 and method enables the users to access the unique keyboard layouts for more than 2600 languages, with their complete character set(s) stored in the server 104, according to one or more embodiment of the present invention. The unique keyboard layouts for all the languages, including the 2600 languages stored in the server 104, is made available to the users in form of unique keyboard layouts that can be imprinted or incorporated onto the physical keyboards of the electronic devices 102 such as, keyboards, typewriters and other typing devices having physical keyboards. FIG. 8 shows a physical keyboard having keys arranged based on the custom keyboard chart in a QWERTY layout. These keyboards or typing devices 102 having the custom keyboard layouts obtained by imprinting the characters, punctuation marks and the special characters of the custom keyboard layout on the physical keys of the device allow the users to type or text in that language effortlessly. The present keyboard having keys imprinted with letters, and other marks based on the custom keyboard chart of a particular language is especially helpful for the native speakers of that language and others typing or texting in that language.

The present computer-implemented system 100 and method for creating unique keyboard layouts for many regional languages and its local variations and providing unique keyboard layouts in form of interactive soft keyboards through the interactive soft keyboard application running on the electronic devices 102 or in form of a physical keyboard with the characters of the selected language imprinted on the keys has a wide variety of applications in the communication sector. In some instances, the present method enables the users to create same keyboard inputs for many of the languages sharing common characters, font and characters with similar sounds and shape. For instance, all the languages typed with the LaserAmharic in Unicode use the same syllabary keyboard layouts or the same keyboard input software or package. All the AfroRoman in Unicode supported languages can be typed with either of two keyboard layouts or two keyboard input software layouts, one using OpenType programming, the other using Dead Keys. The present method can also be used to create optimized OpenType and Dead Key keyboards for Yoruba since it and other languages related to it can be typed much more conveniently with these unique custom keyboards. In some other instances, the present method provides unique key guides for each character of at least 2600 languages, which includes many regional languages and its local variations of these languages that are digitally stored in the server 104. In case of non-digitized languages, these languages are first digitized and stored in the memory unit of the server 104 using the above stated methods before analyzing the character set(s) of these languages to create the unique keyboard charts or layouts and the unique key guides. The present method of creating the digital character set(s) and associated unique keyboard layouts provides 2600 or more highly crafted and individualized keyboard designs for more than 2600 languages used around the world, which are also digitally stored in the server 104, with unique key guides.

The present system 100 and method for creating unique keyboard layouts for many regional languages and its local variations and providing unique keyboard layouts in an interactive soft keyboard form through the interactive soft keyboard application running on the electronic device 102 has a wide variety of applications including such as in text messaging services, social networking, digital marketing, use by mobile service providers, application developers, electronic device manufacturers, printing and publishing companies, etc. For example, a printing and publishing company can download the interactive soft keyboard application having an interactive soft keyboard. The printing and publishing companies can access a desired language set(s) from the server 104 using the interactive soft keyboard application running on their electronic device 102. The interactive soft keyboard application allows the printing and publishing companies to download the character set(s) of desired languages and associated unique keyboard layouts, using their electronic devices 102 to create texts in that particular language. Hence the printing and publishing companies can utilize the present system 100, the stored character set(s) in the server 104 and the unique keyboard layouts to create and publish texts in more than 2600 languages without the need for machine translation. Further, the present interactive soft keyboard application having support for unique keyboard layouts of more than 2600 languages would enable the mobile service providers to communicate with their customers in the customer's native language, through text. Moreover, the application developers can utilize the digital language sets and the unique keyboard layouts for more than 2600 languages available through the present interactive soft keyboard application to deliver contents in customer's or user's local language instead of a common language such as English. The social networking companies and other digital marketing agencies can also use the present digital language sets and the unique keyboard layouts for more than 2600 languages available through the present interactive soft keyboard application to deliver contents in their individual user's native language and also helps them to receive comments from the users in the user's native language, via text. Further, the electronic device manufactures can also use the present digital language sets and the unique keyboard layouts for more than 2600 languages to provide electronic devices 102 with ergonomic physical keys representing characters in the native language of the customers for easy use of their sets devices 102, such as features phones or phones with physical keyboards.

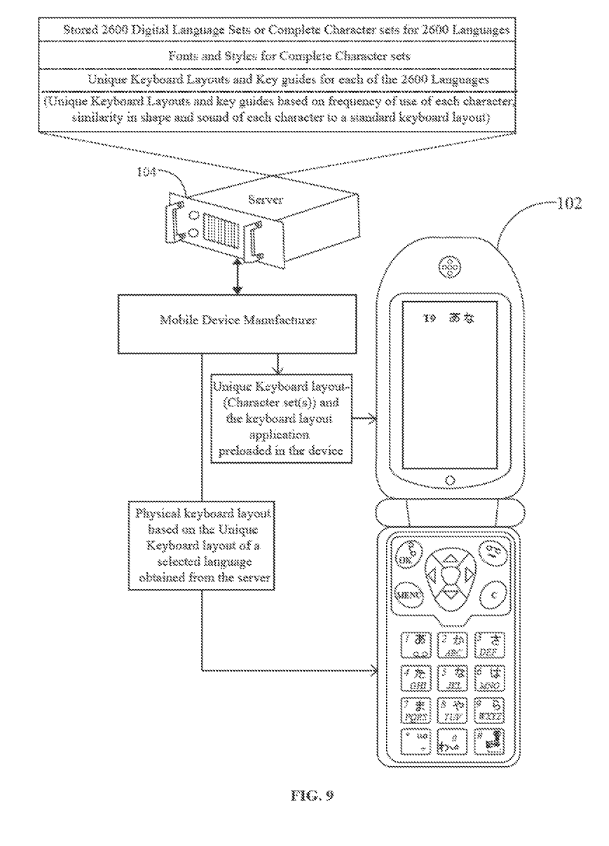

One of the applications of the custom keyboard layouts created using the present computer-implemented system 100 and the associated method is described below with the help of the figure FIG. 9. The present system and method allows the mobile device manufactures to obtain the character set(s) and the keyboard layouts for the desired language and the keyboard layout can be preinstalled installed within the device 102 or based on the demand from the user. Then the mobile device manufacturer can design the keyboard layout as per the keyboard layout obtained from the present system 100. The final device 102 includes the regional languages of the user, which will allow the users to text or type and send messages to others in their native languages. Further, it also allows the users to use the Internet and other online services from their devices 102 using their native language keyboard layout provided on the device. Since texting is the main form of communication in third world countries, the present system 100 and the keyboard layouts can be used by people in these countries to communicate with each other in their native languages. The mobile phone companies can sell mobile phones having native language keyboard to their customers this in turn will improve the usage of the texting and other text related services offered through the mobile phone, as the customer or the users can easily type or text in their native language using the native language keyboard provided with the device 102.

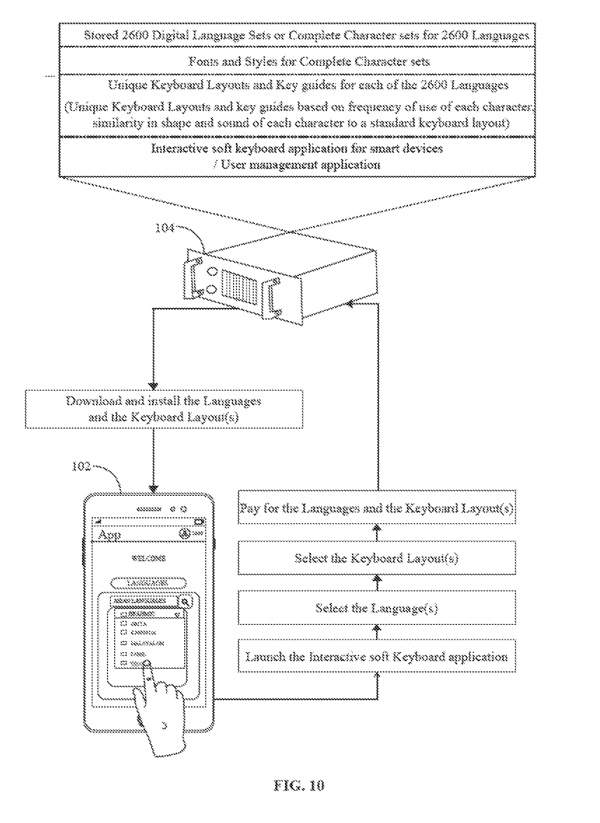

Another use of the custom keyboard layouts of one or more languages created using the present computer-implemented system 100 and the associated method is described below with the help of the figure FIG. 10. The users can launch the interactive soft keyboard application from their electronic device 102 and can connect to the server 104 to search for a desired language and view and download the keyboard layouts available for that language. Once the user selects the desired language as shown in figure, he/she can pay for the desired language and the keyboard layout through an online payment system integrated with the present system 100, and after successful payment, the users can download the language pack including the keyboard layout for that language in their electronic devices 102. The present system 100 and the associated interactive soft keyboard application allows the users to select from more than 2600 languages and associated keyboard layouts and character styles and fonts stored in the server 104. The present system further provides access to around 1540 African regional languages and local variations of these languages, access to more than 200 Indian regional languages and other regional languages around the world.

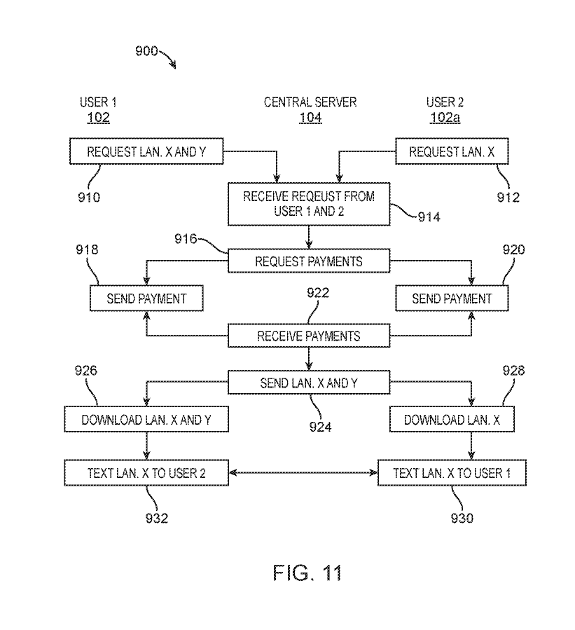

Referring now to FIG. 11, there is one embodiment of a swim lane chart illustrating a potential business method 900 for distribution of up to 2600 languages to individual users using individual languages for texting. In particular, there is illustrated three swim lanes showing the process of the business method 900, where there is a first user 102, a central server 104, and a second user 102a. Wherein, the process begins after the users have purchased their respective communication devices, and both users 102, 102a make a request 910, 912 of the central server 104 for desired language(s) X and Y as illustrated out of the potential language database of up to 2600 languages stored on the central server 104. Whereby, the central server 104 receives 914 the request from user 1 and 2, and thereby may send 916 a request for payment related to the language request.

Different languages may have different pricing, and more languages ordered may have different pricing. Wherein, it may be that the pricing is provided on a web site or published somewhere available to the users, thereby the central server 104 may not need to send a request for payment. The users 1 and 2 will send in a payment 918, 920 corresponding to the requested languages. Next, the central server 104 will receive payments 922 from the users 1 and 2 relating to the respective language download requests. Upon receipt of the appropriate payment, the central server 104 will thereby locate the requested languages out of a database of about up to 2600 and send 924 the requested language(s) X and Y to the appropriately requested users 102 and 102a. Wherein, the respective language(s) will be downloaded onto the appropriate and respective communication device 926, 928. Where user 1 will download language X and Y, and user 2 will download just language X as illustrated. Finally, user 1 is now able to text back and forth 932, 930 with user 2, in the commonly downloaded language X, and thus save considerable money from not having to communicate via voice, which is more expensive than purely texting.

Further, it should be noted that the steps described in the method of use could be carried out in many different orders according to user preference. The use of “step of” should not be interpreted as “step for”, in the claims herein and is not intended to invoke the provisions of 35 U.S.C. § 112, (6). Upon reading this specification, it should be appreciated that, under appropriate circumstances, considering such issues as design preference, user preferences, marketing preferences, cost, technological advances, etc., other methods of use arrangements, elimination or addition of certain steps, including or excluding certain maintenance steps, etc., may be sufficient.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A system to enable a first and second electronic device to select at lest one digitized language from up to about 2600 digitized languages and thereby send text messages in the selected language between the first and second electronic device, comprising the steps of:
a. acquiring a first and second electronic device;
b. providing a central server for storing up to about 2600 digitized languages;
c. requesting, from the first and second electronic device, access to a first digitized language out of the up to about 2600 digitized languages;
d. locating the requested first digitized language in the central server out of the database of up to about 2600 languages;
e. allowing the first and second electronic device to download the requested first digitized language out of the up to about 2600 digitized languages on to the first and second electronic device; and
f. sending a text message from the first electronic device to the second electronic device using the first digitized language received from the central server.

2. The system of claim 1, further comprising the step of sending from the central server a request for payment related to the first digitized language to the first and second electronic device.

3. The system of claim 2, further comprising the step of receiving a request for payment from the central server at the first and second electronic device.

4. The system of claim 3, further comprising the step of sending an appropriate payment from the first and second electronic device to the central server.

5. The system of claim 4, further comprising the step of receiving the associated payment from the first and second electronic device at the central server.

6. A computer-implemented system for allowing a plurality of users to use at least one text input in a plurality of languages, the system comprises:
a) an electronic device having at least one processor capable of executing a plurality of instructions of a plurality of applications including an interactive soft keyboard application;
b) a memory unit in communication with the processor for storing the plurality of instructions of the interactive soft keyboard application capable of being executed by the processor to allow the users to provide the text inputs in the plurality of languages including a plurality of digitized languages and non-digitized languages;
c) at least one server in communication with the interactive soft keyboard application running on the electronic devices to provide an interactive soft keyboard for each of the plurality of languages,
wherein the server stores a plurality of complete character sets for a plurality of languages and a plurality of custom keyboard layouts based on the complete character sets for each of the plurality of languages and made accessible to the electronic devices through the interactive soft keyboard application running on the electronic devices; and
wherein the interactive soft keyboards for each of the languages displayed through the interactive soft keyboard application running on the electronic devices is based on the plurality of custom keyboard layouts stored in the server; and
d) a wireless communication network for enabling communication between the electronic devices and the server for receiving the plurality of custom keyboard layouts based on the complete character sets for each of the plurality of languages stored in the server;
whereby the interactive soft keyboards on the electronic devices presents the custom keyboard layouts for each of the languages stored in the server and having a plurality of characters, a plurality of punctuation marks and a plurality of special characters forming the complete character sets of the language arranged in a unique layout close to an arrangement of a standard keyboard layout including a QWERTY keyboard layout.

7. The computer-implemented system of claim 6, wherein the custom keyboard layouts for each of the languages stored in the server includes a plurality of keys assigned to the plurality of characters, the plurality of punctuation marks and the plurality of special characters of the language based on:
a. a frequency of use of each the characters, the punctuation marks and the special characters in the language;
b. at least one similarity in a shape of the character, the punctuation mark and the special character in the language with the shape of the character, the punctuation mark and/or the special character in a widely used language having a standard keyboard layout; and
c. at least one similarity in a sound of the character, the punctuation mark and the special character in the language with the sound of the character, the punctuation mark and/or the special character in the widely used language having the standard keyboard layout.

8. The computer-implemented system of claim 7, wherein the standard keyboard layout is selected from a group consisting of a plurality of standard QWERTY-based Latin-script keyboard layouts, a plurality of standard non-QWERTY-based Latin-script keyboard layouts and an established national keyboard layout.

9. The computer-implemented system of claim 8, wherein the widely used language is selected from a group consisting of:
a) a widely used Latin-scripts based language including English having the standard QWERTY-based Latin-script keyboard layout;
b) a widely used Latin-scripts based language having the standard non-QWERTY-based Latin-script keyboard layout;
c) a widely used non-Latin alphabetic scripts based language having the standard non-QWERTY keyboard layout; and
d) a widely used non-Latin alphabetic scripts based language having the established national keyboard layout.

10. The computer-implemented system of claim 9, wherein the interactive soft keyboard application launched from the electronic device allows the users to:
i. search for a desired custom keyboard layout for a selected language having the complete character sets stored in the server;
ii. download the desired custom keyboard layout for the selected language within the electronic device;
iii. access the interactive soft keyboard displaying the custom keyboard layout for the selected language; and
iv. provide a plurality of textual inputs in the selected language using the interactive soft keyboard launched within a plurality of applications running on the electronic device.
